(19) United States
(12) Patent Application Publication
(10) Pub. No.: US 2024/0264400 A1
(43) Pub. Date: Aug. 8, 2024

(54) CABLE SLACK MANAGEMENT APPARATUS FOR CO-PACKAGED OPTO-ELECTRICAL DEVICES

(71) Applicant: CORNING RESEARCH & DEVELOPMENT CORPORATION, CORNING, NY (US)

(72) Inventors: Lars Martin Otfried Brusberg, Corning, NY (US); David Wesley Chiasson, Edmonton (CA); Riley Saunders Freeland, Corning, NY (US); Martin Hempstead, Painted Post, NY (US); Ulrich Wilhelm Heinz Neukirch, San Luis Obispo, CA (US); David Evan Robinson, Corning, NY (US)

(21) Appl. No.: 18/638,312

(22) Filed: Apr. 17, 2024

Related U.S. Application Data
(63) Continuation of application No. PCT/US2022/046637, filed on Oct. 14, 2022.
(60) Provisional application No. 63/397,634, filed on Aug. 12, 2022.
(60) Provisional application No. 63/287,585, filed on Dec. 9, 2021.
(60) Provisional application No. 63/257,151, filed on Oct. 19, 2021.

(51) Int. Cl. G02B 6/44

(52) U.S. Cl. CPC G02B 6/4448

(57) ABSTRACT

A fiber optic cable manager is provided configured to receive at least one optical fiber optically connecting one or more fiber optic adapters to a fiber optic device. The fiber optic cable manager includes a base, a sidewall extending from the base and defining a cable input opening and a cable output opening, at least one cable optically connecting one or more fiber optic adapters to an opto-electronic device, and a plurality of mandrels extending from the base and interior to the sidewall, the plurality of mandrels and the sidewall are configured to limit bending of the at least one optical to greater than a predetermined bend radius.

### CROSS-REFERENCE TO RELATED APPLICATIONS

This application is a continuation of International Patent Application No. PCT/US2022/046637 filed Oct. 14, 2022, which claims the benefit of priority to U.S. Provisional Application Nos. 63/397,634, filed Aug. 12, 2022, 63/287,585, filed Dec. 9, 2021, and 63/257,151, filed Oct. 19, 2021. The entirety of each forementioned priority application is incorporated herein by reference.

### BACKGROUND

This disclosure generally pertains to cable routing, and more particularly to a cable slack management apparatus.

In fiber optic networks, fiber optic cables may be connected to various fiber optic assemblies (e.g., hardware, housings, enclosures, etc.). The fiber optic cables may include slack in addition to the cabling needed to make optical connections. This slack may enable the cable to be routed in the fiber optic assembly and/or enable removal of a portion of the cable from the fiber optic assembly, such as to facilitate optical connections, e.g. splicing and patching. Additionally, the slack may be used to facilitate repairs or reconfigurations in which a portion of the cable may be discarded. The slack may be stored inside the fiber optic assembly in one or more cable management solutions.

Various solutions for cable management and overlength management are available on the market. In most cases, a tray approach is used, which can be arranged and stacked inside the device. Routing functionalities and overlength-management may be realized by manual winding of single fibers around fixed integrated support structure. In some co-packaged optical solutions including high density small form factor switch deployments, cable management is performed by a “fiber shuffle”, however these fiber shuffles are highly sophisticated and specific to the switch design resulting in a high volume price and limiting serviceability. One fiber shuffle may connect to multiple input and output connections including multiple active alignment coupling processes. If a coupling fails, the entire fiber shuffle may require replacement.

### SUMMARY

To optimally arrange and service cable assemblies within a data center switch requires custom assembly lengths manufactured to +/1 mm tolerances. However, these length tolerances would be extremely difficult and costly to implement within current manufacturing processes and the number of specific lengths needed to make up the switch is significant. Due to the length variation of the incoming cable assemblies, it is desired to incorporate an excess amount of length within a set number of assembly lengths and then efficiently manage the excess length within the switch.

Additional features and advantages will be set forth in the detailed description which follows, and in part will be apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1 is a schematic diagram of an exemplary FTTx network according to an example embodiment;

FIG. 2 illustrates an example fiber optic assembly having assembly length variation according to an example embodiment;

FIG. 3 illustrates a perspective view of an example cable manager according to an example embodiment;

FIG. 4 illustrates a Monte Carlo simulation of cable lengths for a fiber optic assembly according to an example embodiment;

FIG. 5 illustrates an example cable manager according to an example embodiment;

FIG. 6 illustrates another example cable manager according to an example embodiment;

FIG. 7 illustrates schematic view of an example cable manager and various fiber routing paths according to an example embodiment;

FIG. 8 illustrates an isometric view of a fiber optic assembly including a plurality of cable managers arranged in a horizontal stack according to an example embodiment;

FIG. 9 illustrates a plurality of vertically stacked cable managers arranged in a diagonal configuration according to an example embodiment;

FIG. 10 illustrates an isometric view of fiber optic assembly including an integrated cable manager according to an example embodiment;

FIG. 11 illustrates a top down view of fiber optic assembly including an integrated cable manager according to an example embodiment;

FIG. 12 illustrates a rear detail perspective view of the fiber optic assembly of FIG. 10 according to an example embodiment;

FIG. 13 illustrates an isometric view of the fiber optic assembly having an integrated cable manager including linear and radial cable managers according to an example embodiment;

FIG. 14 illustrates a view of a connector and laser spacing of the fiber optic assembly of FIG. 10 according to an example embodiment;

FIG. 15 illustrates a detailed view of a linear cable manager according to an example embodiment;

FIG. 16 illustrates a detailed view of a of a radial cable manager according to an example embodiment; and

FIG. 17 illustrates an isometric view of two nested cable managers according to an example embodiment.

FIG. 18A illustrates a partial top isometric view of another embodiment of a cable manager according to embodiments disclosed herein.

FIG. 18B illustrates a side isometric view of another embodiment of a cable manager according to embodiments disclosed herein.

FIG. 19 illustrates a side isometric view of a cable manager according to embodiments disclosed herein.

FIG. 20 illustrates a top isometric view of cable managers installed into a fiber optic assembly, according to embodiments disclosed herein.

FIG. 21 is an exploded top isometric view of cable managers shown in FIG. 20.

The embodiments set forth in the drawings are illustrative in nature and not intended to be limiting of the scope of the detailed description or claims. Whenever possible, the same reference numeral will be used throughout the drawings to refer to the same or like features. The drawings are not necessarily to scale for ease of illustration an explanation.

### DETAILED DESCRIPTION

Optical fibers are useful in a wide variety of applications, including the telecommunications industry for voice, video, and data transmissions. The benefits of optical fiber are well known and include higher signal-to-noise ratios and increased bandwidth compared to conventional copper-based transmission technologies. To meet modern demands for increased bandwidth and improved performance, telecommunication networks are increasingly providing optical fiber connectivity closer to end subscribers. These initiatives include fiber-to-the-node (FTTN), fiber-to-the-premises (FTTP), fiber-to-the-home (FTTH), and the like (generally described as FTTx).

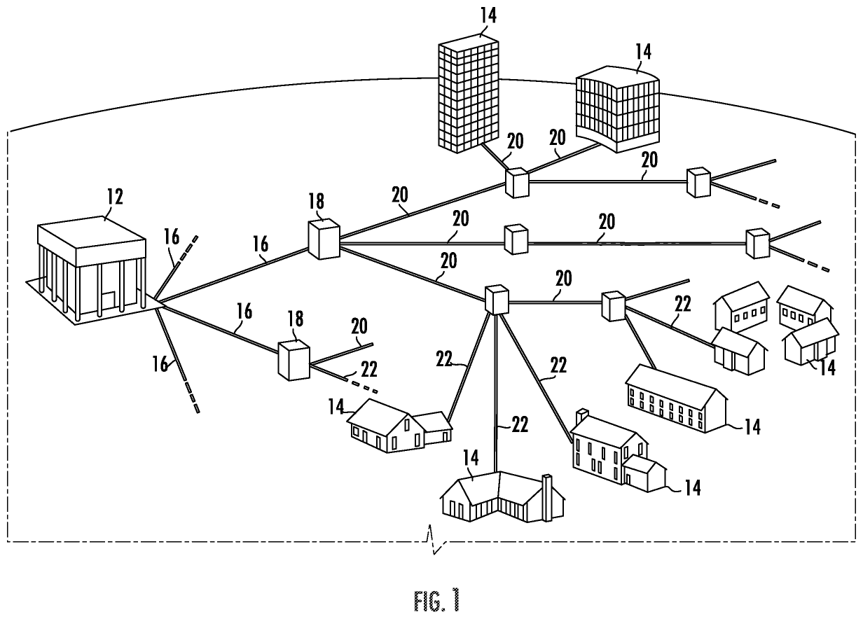

In an FTTx network, fiber optic cables are used to carry optical signals to various distribution points and, in some cases, all the way to end subscribers. For example, FIG. 1 is a schematic diagram of an exemplary FTTx network 10 that distributes optical signals generated at a switching point 12 (e.g., a central office of a network provider) to subscriber premises 14. Optical line terminals (OLTs; not shown) at the switching point 12 convert electrical signals to optical signals. Fiber optic feeder cables 16 then carry the optical signals to various local convergence points 18, which act as locations for splicing and making cross-connections and interconnections. The local convergence points 18 often include splitters to enable any given optical fiber in the fiber optic feeder cable 16 to serve multiple subscriber premises 14. As a result, the optical signals are “branched out” from the optical fibers of the fiber optic feeder cables 16 to optical fibers of distribution cables 20 that exit the local convergence points 18.

At network access points closer to the subscriber premises 14, some or all of the optical fibers in the distribution cables 20 may be accessed to connect to one or more subscriber premises 14. Drop cables 22 extend from the network access points to the subscriber premises 14, which may be single-dwelling units (SDU), multi-dwelling units (MDU), businesses, and/or other facilities or buildings. A SDU or MDU terminal may be disposed at the subscriber premises 14. A conversion of optical signals back to electrical signals may occur at the network access points or at the subscriber premises 14.

There are many different network architectures, and the various tasks required to distribute optical signals (e.g., splitting, splicing, routing, connecting subscribers) can occur at several locations. Regardless of whether a location is considered a switching point, local convergence point, network access point, subscriber premise, or something else, fiber optic equipment is used to house components that carry out one or more of the tasks. The fiber optic equipment may be assemblies that include connectors, switches, splitters, splices, or the like. The term “fiber optic assembly” will be used in this disclosure to generically refer to such equipment (or at least portions thereof). In some instances, such equipment is located at a switching point 12 in an FTTx network, although this disclosure is not limited to any particular intended use. Further, although an FTTx network 10 is shown in FIG. 1, the same considerations apply with respect to other types of telecommunication networks or environments, such data centers and other enterprise network environments.

With increasing needs for higher bandwidth in telecommunication or industrial applications, the number of optical inputs and outputs (I/O) rises drastically. A high I/O count has a resulting increase in optical fiber count inside opto-electronical devices, such as switching points 12. Organization and management of single fibers up to high-density optical cable bundles becomes increasingly necessary as the optical fiber count increases. Fiber routing may be applied to ensure traceable, serviceable, and organized fiber management from optical input to the electronic device observing minimum bend radii. Cable overlength/surplus management may also be utilized because individual I/O routing trace-lengths vary from position to position and cable lengths may be mismatched. Managing high fiber count bundles, for example 92 fibers or 144 fibers, introduces additional challenges because the required fiber bending force is higher compared to individual fibers. Furthermore, optical fibers have a strong spring back tendency and try to straighten if possible, which makes a loose fiber routing difficult.

In current data-center switches (e.g., switches with 12.8 Tbps bandwidth), external fiber-optic connections are generally terminated in pluggable transceivers at the faceplate of the housing. Optical fiber is not generally present within the switch housing where signals are transported electrically via, e.g., copper traces on printed circuit boards. With increasing data rates, these electrical connections are becoming more lossy and progressively distort the transmitted signals. Overcoming electrical loss requires electrical power which is projected to strongly increase for the coming generations of higher-bandwidth switches due to higher data rates and higher numbers of data channels. Such an increase of power consumption poses several problems regarding operational cost, electric power infrastructure, and waste heat management. Going forward, to reduce power consumption, the industry moving toward placement of the transceivers inside the switch housing very close to where the signals are generated: the switch application-specific integrated circuit (ASIC). This effectively replaces long runs of electrical connections with optical-fiber connections, which are virtually loss free for the for the lengths described herein, thus reducing the required signal power. Replacement of the electrical connections with fiber optic connections may necessitate routing of optical fibers within the switch housing. The fiber count can be very high (hundreds to thousands of fibers), and the available space may be very limited driven by many coexisting non-fiber switch components as well as expectations for compact housing sizes. Therefore, the fiber density is expected to be very high within the switch housing.

Details of the fiber routing will strongly impact the case of assembly and serviceability in case of failure of individual switch components. In particular, a crossing-free layout of fiber runs which connect the different transceivers to the faceplate would make the replacement of an individual transceiver with permanently attached fibers far easier as all other fiber runs could remain untouched. Such an orderly routing of many fibers required a tight control of fiber-cable lengths which may be costly to achieve given the length variation in manufacturing.

The constraint placed on the cable assembly lengths will have direct effect on the number of assembly crossovers and will thus affect the ability for an assembly technician to efficiently arrange the cable assemblies and rework/replace defective assemblies. An idealized cable routing scheme would have a multitude of cable assembly lengths that are tailored to a specific route within the switch. Tailoring the length for each cable path results in no cable crossovers and thus will facilitate easier assembly of the switch. This tailored arrangement also allows for easier removal and replacement of “faulty” assemblies that are detected during production quality testing of the switch. However, the ability to create these specific lengths is challenging in current optical fiber cable assembly manufacturing. Some of the manufacturing challenges include management of the groups of cable assembly lengths need thus resulting in stock keeping unit (SKU) proliferation; length variation within groups of cable assembly lengths resulting in crossovers; and rework of cable assemblies may result in a 50 mm reduction in the length of the cable assembly. Significant scrap costs would result without the appropriate management of target lengths for reworked product.

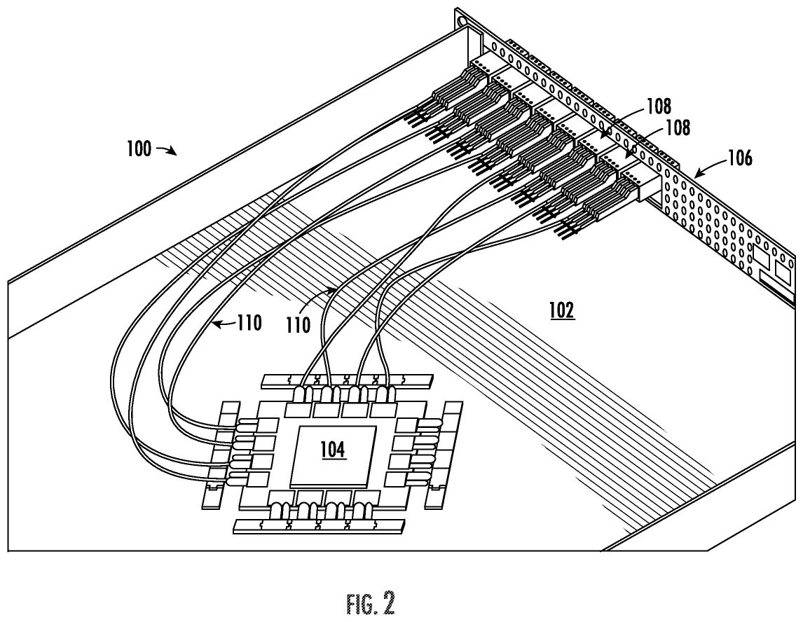

FIG. 2 illustrates an example fiber optic assembly, here a switch housing 100. The switch housing includes a base 102 supporting an opto-electronic device 104, e.g. an ASIC.

The switch housing 100 includes an adapter panel 106 configured to receive one or more fiber optic adapters 108. The fiber optic adapters 108 may be configured to receive a connector such as multi-fiber push-on/pull-off (MPO) connectors (e.g., according to IEC 61754-7). In some examples, the multi-fiber fiber optic components may include very-small form factor (VSFF) connectors or adapters, such as MDC connectors or adapters (sometimes referred to as “mini duplex connectors”) offered by U.S. Conec, Ltd. (Hickory, NC), and SN connectors or adapters (sometimes referred to as a Senko Next-generation connectors) offered by Senko Advanced Components, Inc. (Marlborough, MA). Such VSFF connectors or adapters may be particularly useful in the structured optical fiber cable systems in this disclosure, and may be referred to generically as “dual-ferrule VSFF components” due to their common design characteristic of the connectors having two single-fiber ferrules within a common housing (and the adapters being configured to accept such connectors).

At least one cable 110, also referred to as a “cable assembly”, may be provided optically connecting the one or more fiber optic adapters 108 to the opto-electronic device 104. Introduction of length variations in the cables fiber optic cables on the order of +/−5 mm results in the crossing of cable assemblies which is undesirable. Due to the manufacturing challenges and tight tolerances for variation, “idealized” routing schemes may be cost prohibitive. From a manufacturing perspective several goals emerge: a minimum number of SKUs; allowable length variation within the cable assembly SKUs of greater than +/−5 mm; method to shorten/tailor the length of the cable assembly SKUs after the installation of the Fiber Array Unit (FAU) and the MPO connector; and an efficient arrangement within the switch by minimizing the amount of occupied space within the switch.

Given the orientation of the opto-electronic device 104 to the adapter panel 106, there are two primary paths for the fiber optic cables 110 on each side of the switch housing 100 when using a symmetrical cable routing scheme. One of the primary paths will be the group of fiber optic cables 110 originating at the adapter panel 106 and terminate at the far side of the opto-electronic device 104 and the other primary path will be the group of fiber optic cables 110 that originate at the adapter panel 106 and terminate at the near side of the opto-electronic device 104.

The cable assembly lengths for the near and far side groups of fiber optic cables 110 for an example opto-electronic device 104, e.g. a 256f switch, include a first range of the near side lengths of 219-221 mm (2 mm difference) and a second range of the far side lengths is 447-516 mm (69 mm difference). A larger opto-electronic device 104, such as a switch containing 1024f configuration may include cable assembly lengths for the near and far side groups of fiber optic cables 110 having a first range of the near side lengths is 218-222 mm (4 mm difference) and the second range of the far side lengths is 435-516 mm (81 mm difference).

If an ideal cable routing scheme with an allowable length variation of +/−1 mm following number of SKUs for each of the above switches:

TABLE 1

| | |
|---|---|
| 256f Switch | 1024f Switch |

| | Near Side | Far Side | Near Side | Far Side |
|---|---|---|---|---|
| Required # of | 1 | 4 | 2 | 16 |
| SKUs | | | | |

In order to maximize efficiencies within the cable assembly manufacturing process, it is desired to minimize the number of cable assembly SKUs. It is also desired to salvage/rework any cable assemblies that fail any in process QC checks. Reworked cable assemblies are assumed to consume 50 mm of the original cable assembly length.

In an example embodiment a cable manager may be provided, as disclosed herein to 1) ensure proper cable routing within the switch with a cable assembly length accuracy of +/−1 mm, 2) ensure the ability to gain access to individual cable assemblies withing the switch; 3) minimize cable assembly SKUs to maximize cable assembly manufacturing efficiency, and/or 4) accommodate reworked (shortened) cable assemblies require that a longer than required cable assembly be manufactured and its length subsequently adjusted (i.e. shortened) to within +/−1 mm for the particular cable route required. It is proposed that an apparatus to accumulate excess length of the cable assembly be incorporated as part of the cable assembly and that this adjustment function be performed within a post cable assembly process step.

The accumulation, within a cable manager 120, of length of the fiber optic cable 110 within a post cable assembly process step may enable length tolerances of +/−1 mm and thus enable accurate placement of the cable assemblies within the switch housing 100. A length tolerance of +/−1 mm for the fiber optic cable 110 will ensure no cable assembly crossovers and thus reduce complexity of assembly of the cable assemblies within the switch housing 100 and also allow for any cable assembly that is “flagged” during switch testing to be easily accessed and replaced if necessary.

The trimming/adjustment of cable assembly length within a post cable assembly process may allow for a larger cable assembly length tolerance than that required for the length tolerance for a specific cable route. For example, an allowable length tolerance of +/−5 mm of a fiber optic cable 110 may be acceptable in the cable assembly process given that the subsequent accumulation trough process can adjust the length to within +/−1 mm.

The post adjustment of length will also enable a reduction in the number of cable assembly SKUs required and reduce the number of scraped cable assembly SKUs that cannot be reworked. For example, it is anticipated that the total number of SKUs for the 256f switch and the 1024f switch can be reduced from 5 to 2 and 18 to 2, respectively. Both the SKU reduction and the reduction in possible scrap will have a significant effect on reducing the cost of the finished switch.

To adjust the length of a fiber optic cable 110 within a post cable assembly process, the length of the fiber optic cable 110 must be longer than that of the target length. In an example case, the fiber optic cable 110 may have a length variation of +/−5 mm. An additional assumption provides that reworked cable assemblies will be 50 mm shorter than the original length and have an inherent length variation, e.g. +/−5 mm. In this example, there are two groups of fiber optic cables 110 for each of the near and far side of the cable routes, relative to the opto-electronic device 104. One group of fiber optic cables 110 may be the first pass cable assemblies and the other group of fiber optic cables 110 may be reworked cable assemblies. For each of the cable assemblies to be used for any of the respective near side or far side routes, the shortest cable assembly length may be adjusted for the longest cable route while the longest cable assembly length may be adjusted to the shortest cable route. The length to be accumulated for the near and far side cable assemblies depends on the following parameters: 1) cable assembly length variation, e.g. +/−5 mm in the present example; 2) cable route length variation; 3 minimum cable assembly length for the cable manager 120, e.g. the cable length at a maximum extension from the cable manager 120, here 50 mm; and 4) the length of fiber optic cable 110, assumed to be 50 mm.

An example calculation of the target cable assembly length and the accumulated fiber optic cable 110 for the near and far side routes are provided below.

$$Longest Far Side Route : 516 mm = Shortest Ideal Cable Assembly Length . \qquad EQN . 1$$

$$Shortest Cable Assembly Length = 516 mm + 50 mm + 50 mm ( rework buffer ) + 50 mm ( min accumulation trough length needed ) = 616 mm \qquad EQN . 2$$

$$Longset Cable Assembly length ( + / - 5 mm length variation ) : 616 mm + 10 mm = 626 mm . \qquad EQN . 3$$

$$Necessary accumulation length : Longest Cable Assembly Length - Shortest path - 50 mm ( accumulation length ) 626 mm - 435 mm - 50 mm = 141 mm \qquad EQN . 4$$

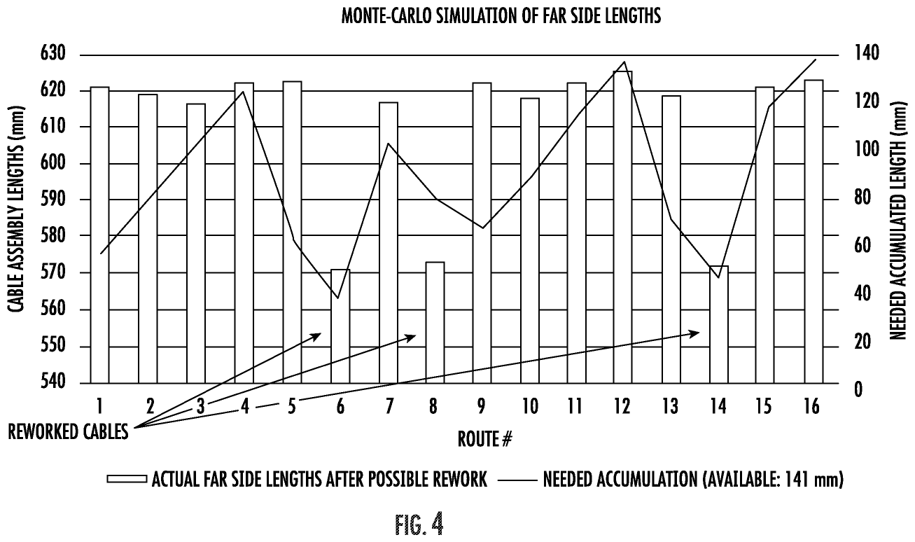

FIG. 4 illustrates a Monte Carlo simulation using the above target cable assembly lengths, a 20% rework rate, and the random placement of the cable assemblies in the cable far side routes was done to calculate the needed accumulation. The graph shows that the calculated accumulated length is sufficient to accommodate the variation in cable assembly length and the needed 50 mm of rework length such that all cable assemblies can be adjusted to the necessary cable length.

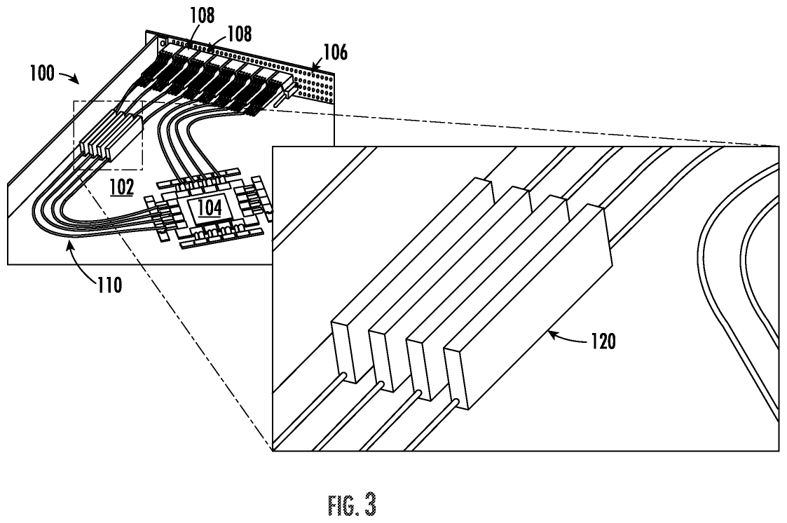

Returning to FIG. 3, the cable manager 120 may be designed to minimize the amount of space occupied by the accumulated length of fiber optic cable 110, such that the height, width, and depth occupied by the cable manager is minimized, as shown in detail A. Minimizing the dimensions of the cable manager 120 may ensure air circulation is not impaired significantly and that the cable manager 120 may be installed and removed from the switch housing 100 without significantly disturbing adjacent assemblies.

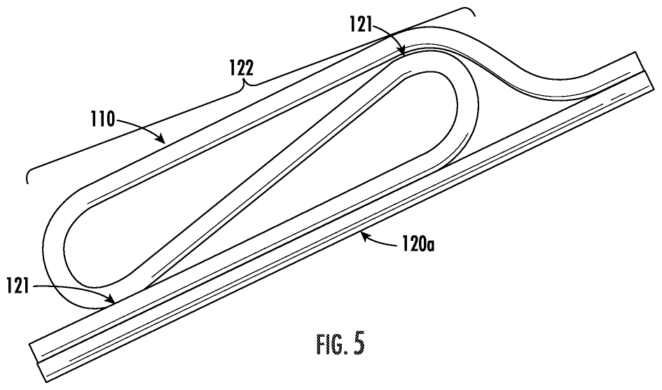

FIG. 5 illustrated the simplest form of accumulation of slack in the fiber optic cable 110. In this example, a ridge support is provided as a cable manager 120a. The fiber optic cable 110 may be affixed to the cable manager 120a, such as by an adhesive. A portion of the fiber optic cable 110 may extend outward from the cable manager 120a, such is in a slack loop 122. The slack loop 122 may be affixed, by an adhesive, to the fiber optic cable 110 at a point affixed to the cable manager 120a, such as at a glue connection 121. Additionally, the slack loop may be affixed to itself at one or more glue connections 121. The glue connections 121 may be positions such that the fiber optic cable 110 occupies a minimum volume while maintaining a minimum bend radius. The cable manager 120a of FIG. 5 may not provide sufficient control of the fiber path.

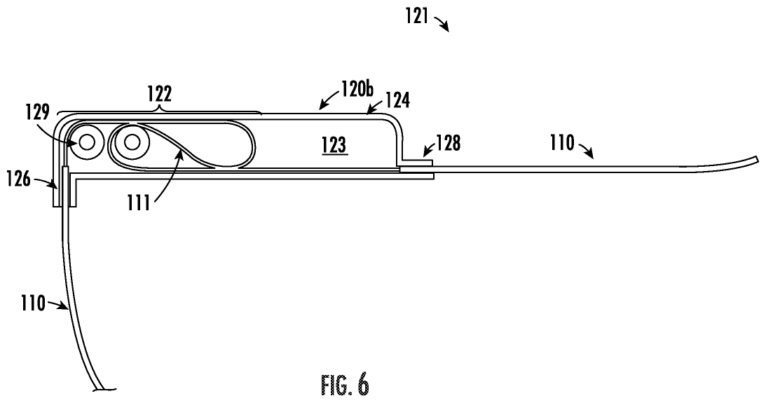

FIG. 6 illustrates another example cable manager 120b. The cable manager 120b may include a base 123 and a sidewall 124 extending outward from the base. The sidewall 124 may be intermittent or continuous and have one or more sections. The sidewall 124 may define a cable input opening 126 and a cable output opening 128. In some embodiments the cable input opening 126 and/or the cable output may be configured to retain the fiber optic cable 110. For example, the cable input opening 126 and/or cable output opening 128 may have features to cooperate with a retention element, such as a cable tie, rubber band, or the like, which may compress a portion of the sidewall 124 against an outer jacket of the fiber optic cable 110 and resist movement. In some example embodiments, the cable input opening 126 and/or cable output opening 128 may be configured to retain the fiber optic cable 110 by an interference fit or friction fit with the jacket of the fiber optic cable 110 or with an unjacketed portion 111 of the fiber optic cable 110. Additionally, or alternatively, an adhesive may be utilized to reattain the fiber optic cable in the cable input opening 126 and/or cable output opening 128.

The cable manager 120 may also include one or more mandrels 129 extending from the base 123 and internal to the sidewall 124. The mandrels 129 in cooperation with sidewall 124 are configured to enable bending of the fiber optic cable to greater than a predetermined minimum bend radius, such as 5 mm, 8 mm, 10 mm, 12 mm, or other suitable bend radius. The mandrels 129 may also define one or more cable routing paths within the cable manager 120b. In the mandrels 129 may enable a slack loop 122 to be routed inside the cable manager 120b without utilization of adhesives, which may make reworking of the fiber optic cable 110 easier and faster.

In some example embodiment, the fiber optic cable 110 may include a rollable ribbon or intermittently boded ribbon disposed within a cable jacket. Ribbon(s) may be conventionally coated, substantially coated, or continuously coated. In an example embodiment, a portion of the cable jacket may be removed to from an unjacketed portion 111. The unjacketed portion 111 may be “unrolled” into a planer rollable ribbon, which may provide a smaller minimum bend radius. The unjacketed portion 111 may be routed within the cable manager 120b including the slack loop 122, thus enabling a smaller footprint that would be otherwise possible with the jacketed and/or bunched rollable ribbon.

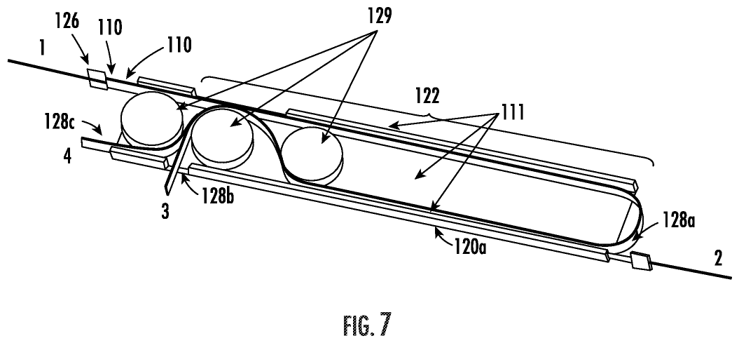

Turning to FIG. 7 various cable routing paths are illustrated. The cable manager 120b may include a first end proximate or including the cable input opening 126 and a second end opposite the first end. A first cable routing configuration may be defined as “1-2: horizontal” in which the fiber optic cable 110 enters the cable manager 120b at the cable input opening 126 at the first end and is routed to the second end. The fiber optic cable 110 may then be looped back to a mandrel 129 near the first end and then back to the second end and exit through an output opening 128a disposed in the second end. A second cable routing configuration may be defined as “1-3: right angle”. The fiber optic cable 110 enters the cable manager 120b at the cable input opening 126 at the first end and is routed to the second end. The fiber optic cable 110 may then be looped back to a mandrel 129 near the first end and exit through an output opening 128b disposed in the sidewall 124 between the first end and the second end. A third cable routing configuration may be defined as “1-4: horizontal, 180-degree turn”. The fiber optic cable 110 enters the cable manager 120b at the cable input opening 126 at the first end and is routed to the second end. The fiber optic cable 110 may then be looped back to the first end and exit through an output opening 128c disposed in the first end. The disclosed cable routing configurations are merely examples, other configurations are contemplated. The different cable routing configurations enable flexibility of placement of the fiber optic cables 110 within a switch housing 100 with a horizontally placed cable manager 120b.

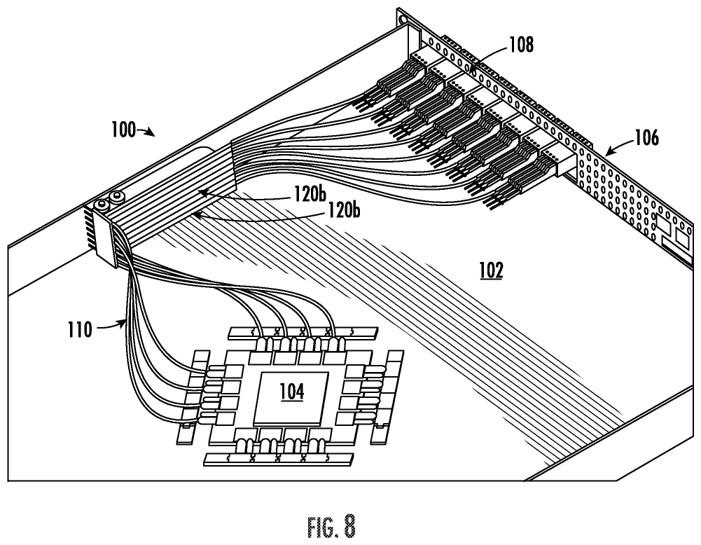

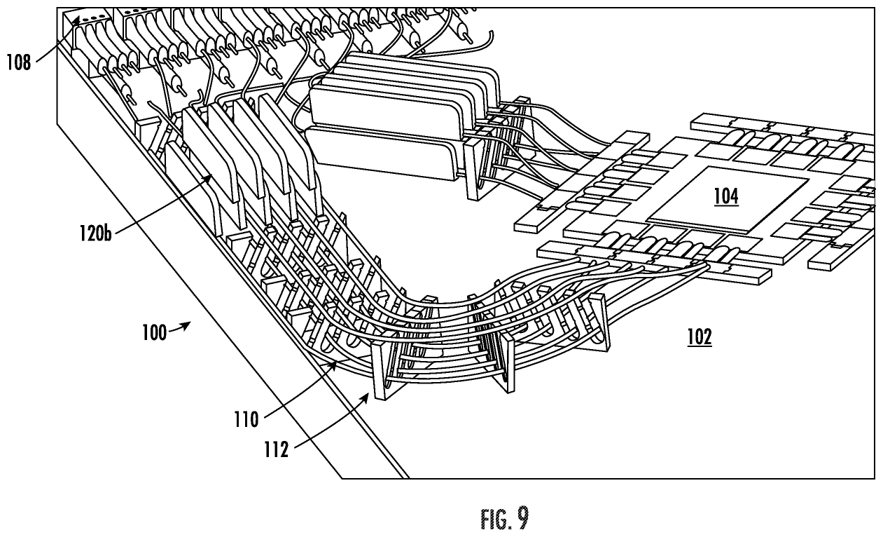

In an example embodiment, the cable manager 120b may have a length of 20-200 mm; a height of 15-25 mm; and a width of 2-10 mm. The cable manager 120b may include 2, 3, or any suitable number of mandrels to control a path of the fiber optic cable 110 and an internal bend radius of 5-10 mm, 10-15 mm, 15-25 mm, or other suitable bend radii for the fiber optic cable 110. The cable manager 120b may be horizontally stacked, such as depicted in FIG. 8 to minimize space. In the example depicted in FIG. 9 the cable managers are disposed in a vertical orientation within the switch housing 100 which enables access to each cable assembly and cable manager 120b. FIG. 9 also depicts diagonal stacking of vertical orientated cable managers 120b. The diagonal stacking may include a vertical and lateral offset between cable managers 120b to enable “unobstructed” access to individual cable assemblies while minimizing the footprint of the arrangement within the switch housing 100. In an example embodiment vertically raised cable managers may include a support structure to define the vertical offset. The support structure may be a separate element or may be integral to the cable manger 120b. In some embodiments, a diagonal cable routing guide 112 may be provided to facilitate fiber management between the cable manger 120b and the opto-electronic device 104.

In some embodiments, the fiber optic cable 110 within the switch housing 100 may be unjacketed. In an example embodiment, the fiber optic cable 110 within the switch housing 100 may be pre-shaped to aid in switch assembly/cable routing. The pre-shaping of the fiber optic cable 110 may also aide in reducing the need for stress relief at the cable FAU/connector ends.

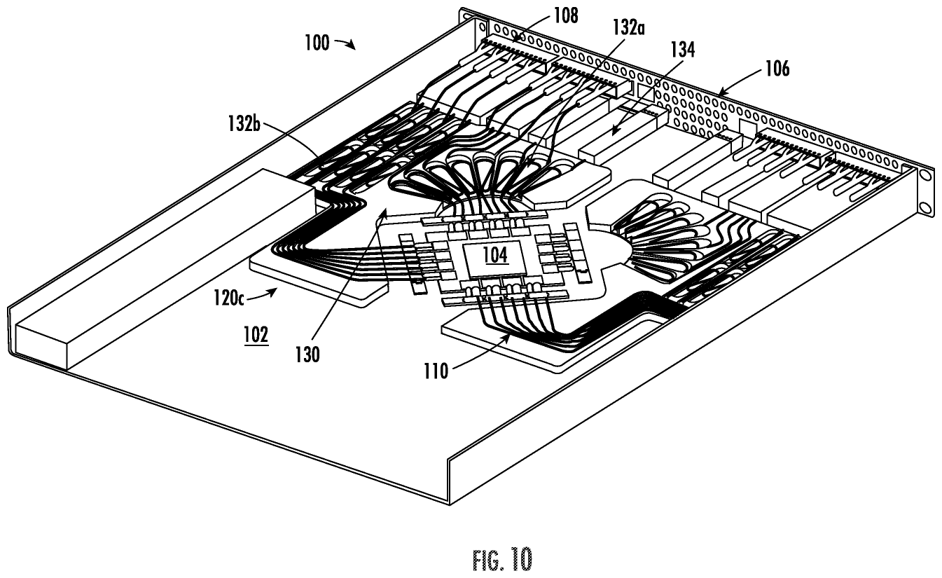

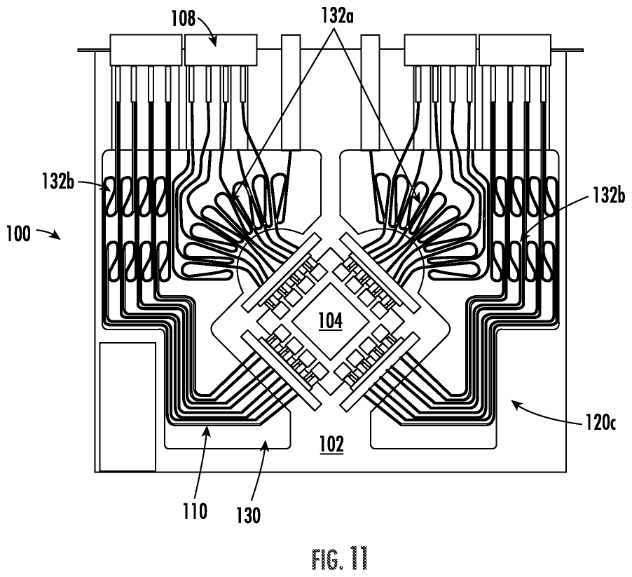

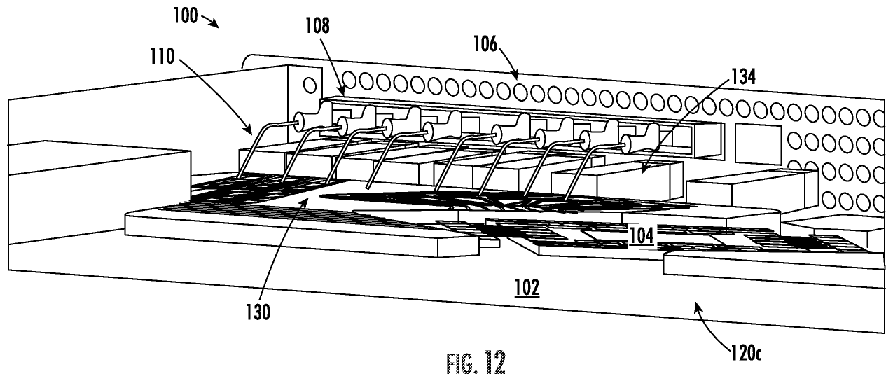

Turning to FIGS. 10 and 11, in another embodiment, the cable manager 120c may include a base 130 and a plurality of cable routing channels disposed in the base 130. The base 130 may be a portion of or attached to the base 102 of the switch housing 100 or may be a separable or removable plate, as depicted in FIG. 10. The base 130 may be formed at a minimum elevation, such a 5 mm, 10 mm, 15 mm, 20 mm, or other suitable height to provide structural stability and enable the fiber optic cable 110 to be fully or partially inserted in the cable channels, as depicted in FIG. 12. The minimal elevation of the base 130 may reduce material consumption and weight of the switch housing 100, and enable maximum air flow within the switch housing 100.

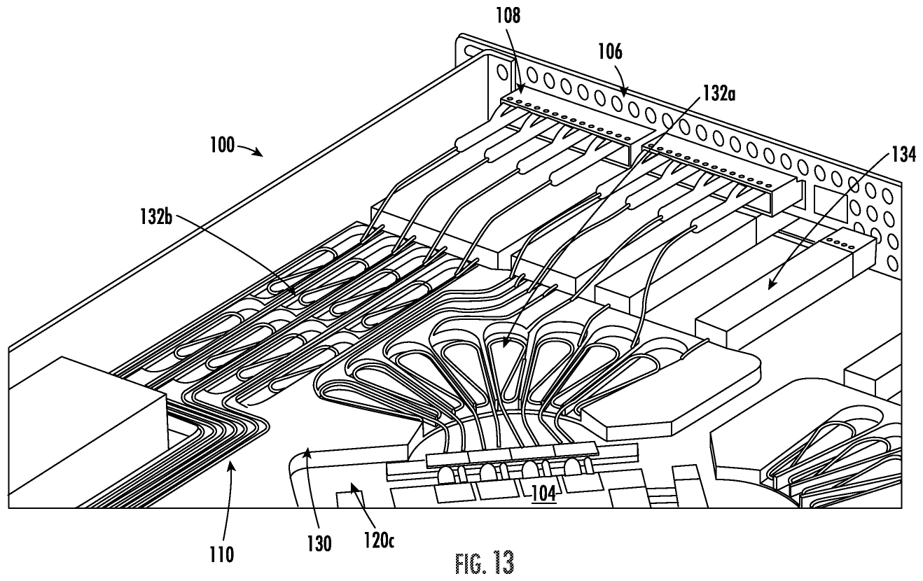

In some example embodiments, the cable manager 120c may include one or more cable accumulation troughs 132 disposed along the cable routing channels, as shown in FIG. 13. The cable accumulation troughs 132 may be configured to limit bending of the fiber optic cable 110 to greater to a predetermined bend radius. The cable manager 120c may have two groups of cable accumulation troughs 132 the first group being a near side group relative to the adapter panel 106 and connection point of the opto-electronic device 104, and the second group being a far side group relative to the adapter panel 106 and the connection to the opto-electronic device 104, as shown in FIG. 11.

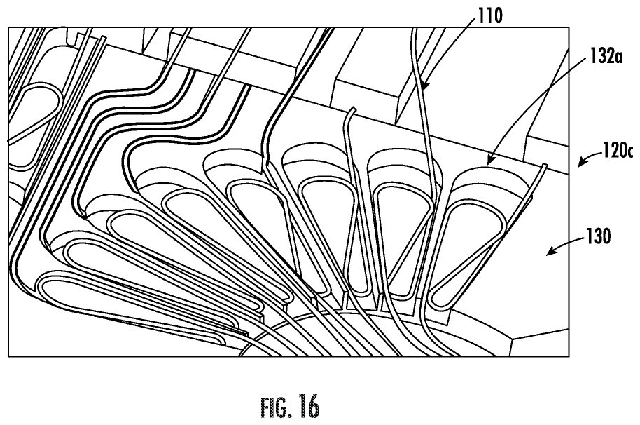

In the depicted embodiment, the near side group of cable accumulation troughs 132 are radial accumulation troughs 132a. The radial accumulation troughs 132a, shown in further detail in FIG. 16, may extend outward from the opto-electronic device 104 in rays. In some example embodiments the radial accumulation troughs 132a may have a generally teardrop shape. A narrow end of the radial accumulation trough 132a may be disposed proximate to the opto-electronic device 104 and a wider round portion of the radial accumulation trough 132a may be disposed at a distal end of the ray. The radial accumulation trough 132a may include an input opening from a cable routing channel, for example disposed at the wider round portion. The radial accumulation trough 132a may also include an output opening to a subsequent portion of the cable routing channel and/or the opto-electronic device 104.

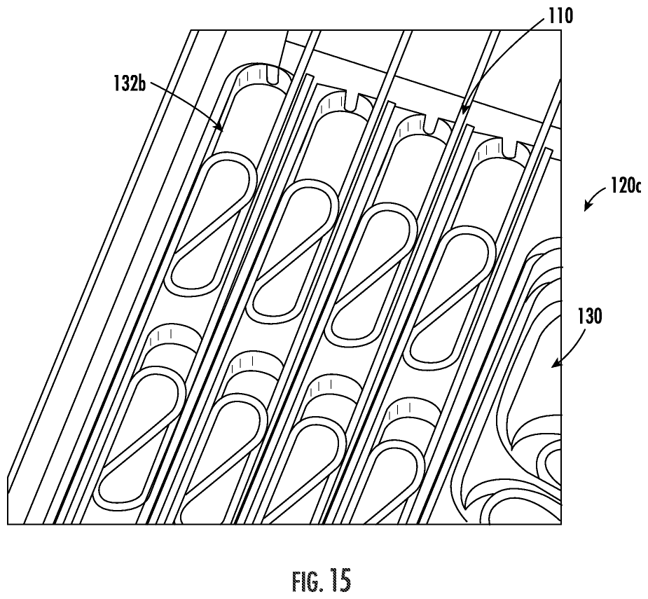

The far side group of cable accumulation troughs 132 are linear accumulation troughs 132b. The linear accumulation troughs 132b, shown in further detail in FIG. 15, may extend linearly in a suitable direction in the base 130. The direction of extension of the linear accumulation troughs 132b may be chosen to minimize the volume taken up by the base 130 and or cable routing. The linear accumulation trough 132b may have a first end and second end. Each end may be curved at or greater than the minimum bend radius of the fiber optic cable 110. The linear accumulation trough 132b may include an input opening from a cable routing channel, for example disposed at the first end. The linear accumulation trough 132b may also include an output opening to a subsequent portion of the cable routing channel and/or the opto-electronic device 104.

In some embodiments, the fiber optic cable 110 may overlap another portion of the fiber optic cable 110 in the cable accumulation trough 132. The overlap may maximize the bend radius and eliminate cable twist, with a negligible increase in height of the base 130.

In an example embodiment, the fiber optic cable 110 may be retained in the cable accumulation trough 132 by friction caused by spring back pressure of the fiber optic cable 110 against the sidewall of the cable accumulation trough 132. In an example embodiment, an adhesive may be used to retain the fiber optic cable 110 within the cable accumulation trough 132. In some embodiments, the cable accumulation trough 132 may include a lip or flange extending inward from base 130 at an upper edge of the cable accumulation trough 132. The lip or flange may resist movement of the fiber optic cable 110 out of the cable accumulation trough 132.

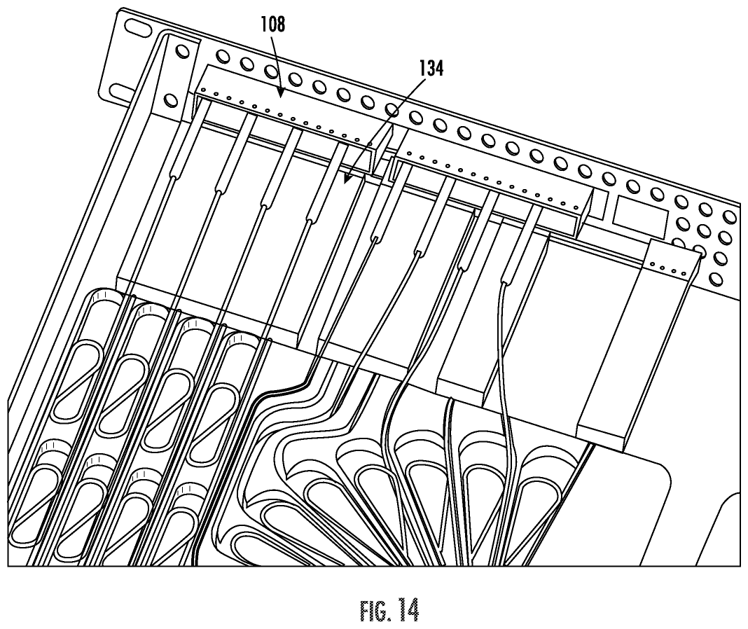

In some example embodiments, the switch housing 100 may include one or more lasers 134, as depicted in FIGS. 12 and 14. In some example embodiments, the lasers 134 may have a uniform spacing. In some example embodiments the lasers 134 and/or the adapters 108 may include a non-uniform spacing to accommodate non-overlapping cable routing paths within the base 130.

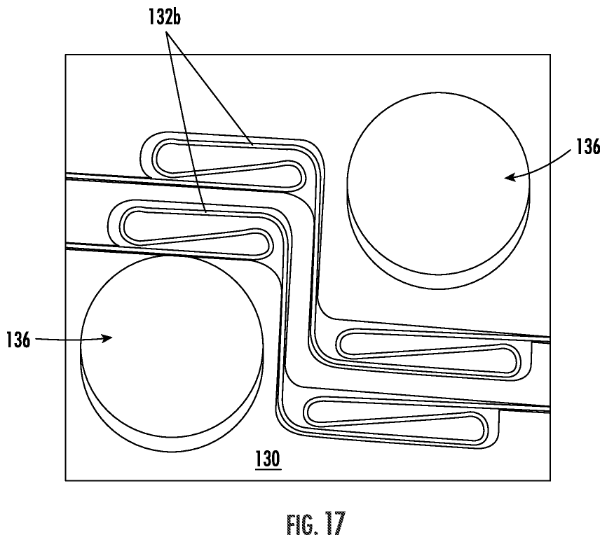

FIG. 17 depicts an example of multiple cable accumulation troughs 132 disposed along a cable routing channel. In some embodiments, an obstacle 136 may exist in the routing path of the fiber optic cable 110. The length of a linear accumulation trough 132b may be split into multiple cable accumulation troughs 132 with a cable routing channel disposed therebetween. In this way, the fiber optic cable 110 may be routed around the obstacle 136 and maintain the cable slack management. In some embodiments, the two or more cable routing channels and associated cable accumulation troughs 132 may be nested, such that they follow a similar cable routing path around the obstacle 136 and minimize the volume utilized for cable routing.

In an example embodiment, a fiber optic assembly is provided including a housing base configured to support one or more fiber optic communication connections, a housing sidewall extending from the housing base, an opto-electrical device supported by the housing base, an adapter panel supporting one or more fiber optic adapters, at least one optical fiber optically connecting the one or more fiber optic adapters to the opto-electronic device, and at least one cable manager supported on the housing base and routing at least a portion of the at least one optical fiber from the one or more fiber optic adapters to the opto-electronic device. The at least cable manager includes a base, a sidewall extending from the base and defining an input opening and an output opening, and a plurality of mandrels extending from the base and interior to the sidewall. The plurality of mandrels and the sidewall are configured to limit bending of the at least one optical fiber to greater than a predetermined bend radius.

In some example embodiments, the at least one optical fiber comprises a plurality of optical fiber ribbons each configured as a rollable ribbon. In an example embodiment, at least a portion of each of the optical fiber ribbons that is disposed within the at least one cable manager is not surrounded by a cable jacket. In some example embodiments, the fiber optic assembly also includes at least one cable that includes the plurality of optical fiber ribbons, where the at least one cable comprises a jacketed portion retained in the input opening or the output opening. In an example embodiment, the plurality of optical fibers have a planar configuration in the at least one cable manager. In some example embodiments, the sidewall further defines a plurality of output openings. In an example embodiment, the plurality of output openings comprise a first output opening disposed at a first end of the at least one cable manager proximate to the input opening and a second output opening disposed at a second end of the at least one cable manager opposite the input opening. In some example embodiments, the plurality of output openings further includes a third output opening disposed in the sidewall between the first end and the second end of the at least one cable manager. In an example embodiment, the at least one cable manger includes a plurality of cable mangers disposed in a horizontal stack. In some example embodiments, the at least one cable manager includes a plurality of cable managers disposed in a vertical orientation extending from the housing base.

In another example embodiment, a fiber optic cable manager is provided configured to receive at least one optical fiber optically connecting one or more fiber optic adapters to a fiber optic device. The fiber optic cable manager includes a base, a sidewall extending from the base and defining a cable input opening and a cable output opening, at least one cable optically connecting one or more fiber optic adapters to an opto-electronic device, and a plurality of mandrels extending from the base and interior to the sidewall, the plurality of mandrels and the sidewall are configured to limit bending of the at least one optical to greater than a predetermined bend radius.

In some example embodiments, the sidewall further defines a plurality of output openings. In an example embodiment, the plurality of output openings includes a first output opening disposed at a first end of the cable manager proximate to an input opening and a second output opening disposed at a second end of the cable manager opposite the input opening. In some example embodiments, the plurality of output openings further includes a third output opening disposed in the sidewall between the first end and the second end.

In yet a further example embodiment, a fiber optic assembly is provided including a housing base configured to support one or more fiber optic communication connections, a housing sidewall extending from the housing base, an opto-electrical device supported by the housing base, an adapter panel configured to receive one or more fiber optic adapters, at least one optical fiber optically connecting the one or more fiber optic adapters to an opto-electronic device, and at least one cable manager supported on the housing base. The at least one cable manager includes a base, a plurality of cable routing channels disposed in the base, and at least one cable accumulation trough disposed along at least one of the plurality of cable routing channels. The at least one cable accumulation trough is configured to limit bending of the at least one optical fiber to greater than a predetermined bend radius.

In some example embodiments, the base comprises a removable plate and the plurality of cable routing channels or the at least one cable accumulation trough is disposed on the removable plate. In an example embodiment, the at least one cable accumulation trough comprises a plurality of cable accumulation troughs. In some example embodiments, at least a some of the plurality of cable accumulation troughs include linear accumulation troughs. In an example embodiment, at least a some of the plurality of cable accumulation troughs comprise radial accumulation troughs.

In yet another example embodiment, a fiber optic assembly is provided including a housing base configured to support one or more fiber optic communication connections, a front wall extending from the base and including an adapter panel supporting one or more fiber optic adapters, lateral housing sidewalls extending from the housing base and disposed at either side of the adapter panel, an opto-electrical device supported by the housing base, at least one optical fiber optically connecting the one or more fiber optic adapters to the opto-electronic device, and at least one cable manager supported on the housing base. The at least one cable manger includes a base, a plurality of cable routing channels disposed in the base, and at least one cable accumulation trough disposed along at least one of the plurality of cable routing channels. The at least one cable accumulation trough is configured to limit bending of the at least one optical to greater than a predetermined bend radius.

In some example embodiments, the at least one cable accumulation trough includes a plurality of cable accumulation troughs, and wherein at least some of the plurality of cable accumulation troughs comprise linear accumulation troughs disposed parallel or perpendicular to the lateral housing sidewalls. In an example embodiment, the at least one cable accumulation trough includes a plurality of cable accumulation troughs, and wherein at least some of the plurality of cable accumulation troughs comprise radial accumulation troughs extending outward from the opto-electrical device.

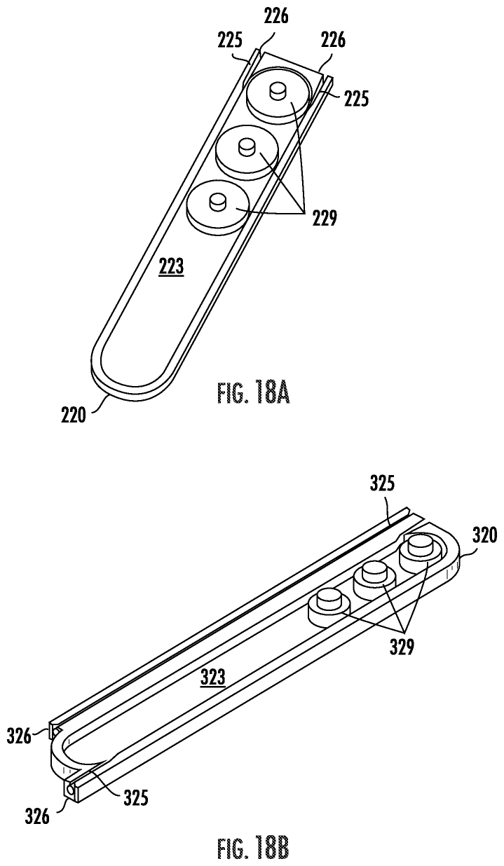

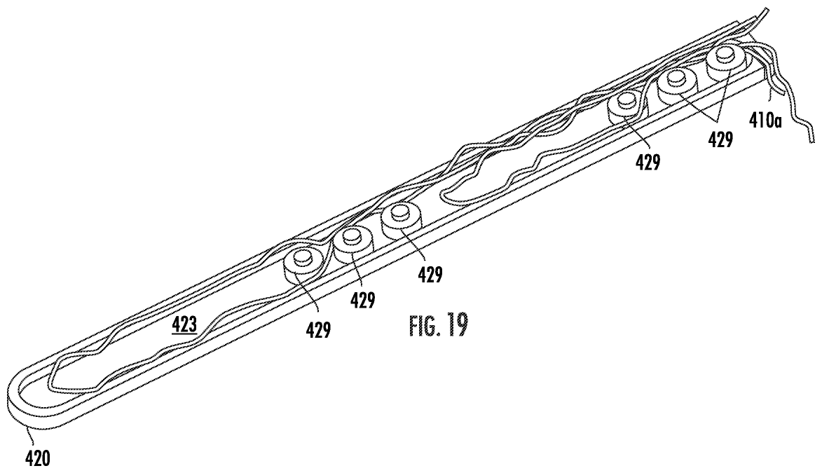

Additional embodiments, as shown with respect to FIGS. 18A, 18B, 19, 20, and 21 may include additional input and output configurations with the input and output being on opposite sides, the same side of the length and width, or in a perpendicular or curved configuration. FIGS. 18A, 18B, and 19 illustrate cable managers 220, 320, 420 for at least one fiber/ribbon/cable within at least one accumulator. For example, fiber/ribbons/cables may run adjacent to one another or be guided within the same accumulation trough (alternatively known as an accumulator) construction. Each cable manager 220, 320c, 420 may include a base 223, 323, 423 and at least one sidewall 224, 324, 424 extending outwardly from the base, which may be intermittent or continuous and have one or more sections and one or more grooves 325, 425, as shown by way of example in FIGS. 18A and 18B, configured to at least partially retain one or more cables. Each sidewall may define a cable input/output opening 226, 326, 426 which may be configured to retain one or more fiber optic cables. Each cable manager 220, 320, 420 may also include one or more mandrels 229, 329, 429 that further facilitate cable management.

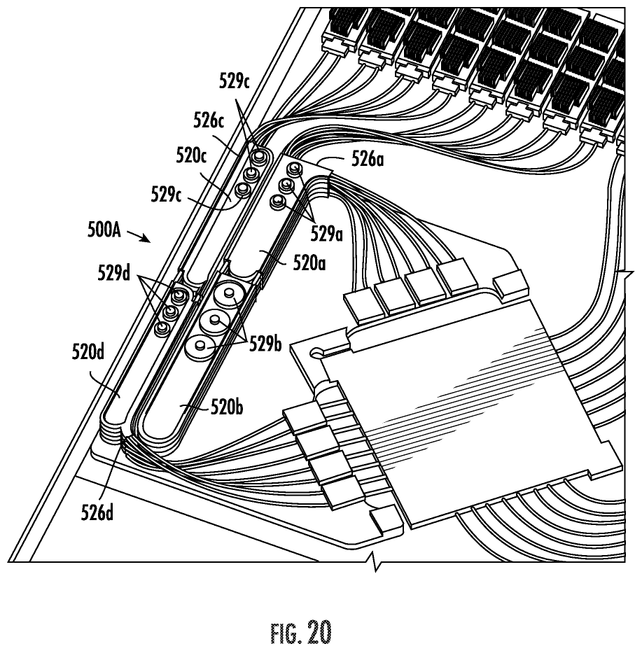

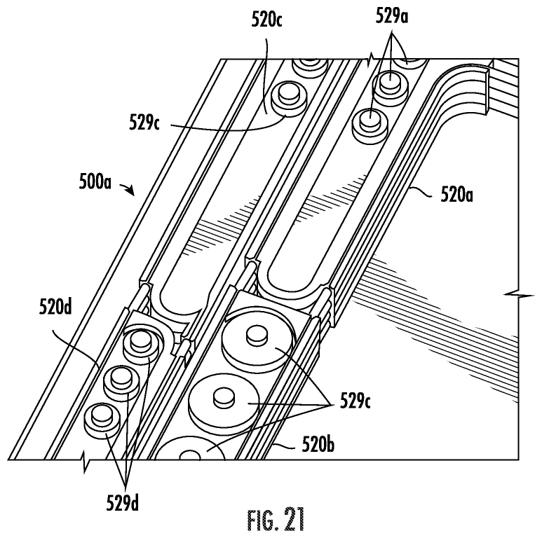

FIGS. 20 and 21 illustrate the guiding of fiber/ribbon/cable from other cable managers/accumulators 520a, 520b, 520c, 520d via input/output openings 526a, 526b, 526c, 526d in a fiber optic assembly 500A. Continuous or discontinuous grooves 525a, 525b, 525c, 525d may also be included in the assembly, thereby allowing for a substantially organized layout of the fiber/ribbons/cables. FIGS. 20 and 21 further illustrate in more detail guiding of the fiber/ribbon/cable from cable managers/accumulators 520a, 520b, 520c, and 520d, using mandrels 529a, 529b, 529c, 529d. Specifically, the groove(s) 525a in cable manager/accumulation trough 520a is used to guide fiber/ribbon/cable to and from cable manager/accumulation trough 520b, and the groove(s) 525c in cable manager/accumulation trough 520c is used to guide fiber/ribbon/cable to cable manager/accumulation trough 520d, and the groove(s) 525d in cable manager/accumulation trough 520d is used to guide fiber/ribbon/cable from cable manager/accumulation trough 520c to the end of cable manager/accumulation trough 520d. Additional configurations of the guiding of cable managers/accumulation troughs are contemplated. Moreover, the number of accumulation troughs or accumulators shown and described herein is not to be construed as limiting, as fewer or additional may be used.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

What is claimed is:

1. A fiber optic assembly, comprising:
a housing base configured to support one or more fiber optic communication connections;
a housing sidewall extending from the housing base;
an opto-electrical device supported by the housing base;
an adapter panel supporting one or more fiber optic adapters;
at least one optical fiber optically connecting the one or more fiber optic adapters to the opto-electronic device; and
at least one cable manager supported on the housing base and routing at least a portion of the at least one optical fiber from the one or more fiber optic adapters to the opto-electronic device, the at least cable manager comprising:
a base;
a sidewall extending from the base and defining an input opening and an output opening; and
a plurality of mandrels extending from the base and interior to the sidewall, wherein the plurality of mandrels and the sidewall are configured to limit bending of the at least one optical fiber to greater than a predetermined bend radius.

2. The fiber optic assembly of claim 1, wherein the at least one optical fiber comprises a plurality of optical fiber ribbons each configured as a rollable ribbon.

3. The fiber optic assembly of claim 2, wherein at least a portion of each of the optical fiber ribbons that is disposed within the at least one cable manager is not surrounded by a cable jacket.

4. The fiber optic assembly of claim 3, further comprising at least one cable that includes the plurality of optical fiber ribbons, where the at least one cable comprises a jacketed portion retained in the input opening or the output opening.

5. The fiber optic assembly of claim 3, the plurality of optical fibers have a planar configuration in the at least one cable manager.

6. The fiber optic assembly of claim 1, wherein the sidewall further defines a plurality of output openings.

7. The fiber optic assembly of claim 6, wherein the plurality of output openings comprise a first output opening disposed at a first end of the at least one cable manager proximate to the input opening and a second output opening disposed at a second end of the at least one cable manager opposite the input opening.

8. The fiber optic assembly of claim 7, wherein the plurality of output openings further comprises a third output opening disposed in the sidewall between the first end and the second end of the at least one cable manager.

9. The fiber optic assembly of claim 1, wherein the at least one cable manger comprises a plurality of cable mangers disposed in a horizontal stack.

10. The fiber optic assembly of claim 1, wherein the at least one cable manager comprises a plurality of cable managers disposed in a vertical orientation extending from the housing base.

11. A fiber optic cable manager comprising:
a base;
a sidewall extending from the base and defining a cable input opening and a cable output opening;
at least one optical fiber configured to optically connect one or more fiber optic adapters to an opto-electronic device; and
a plurality of mandrels extending from the base and interior to the sidewall, wherein the plurality of mandrels and the sidewall are configured to limit bending of the at least one optical fiber to greater than a predetermined bend radius.

12. The fiber optic cable manager of claim 11, wherein the sidewall further defines a plurality of output openings.

13. The fiber optic cable manager of claim 12, wherein the plurality of output openings comprise a first output opening disposed at a first end of the cable manager proximate to the input opening and a second output opening disposed at a second end of the cable manger opposite the input opening.

14. The fiber optic cable manager of claim 13, wherein the plurality of output openings further comprises a third output opening disposed in the sidewall between the first end and the second end.

15. A fiber optic assembly comprising:
a housing base configured to support one or more fiber optic communication connections;
a housing sidewall extending from the housing base;
an opto-electrical device supported by the housing base;
an adapter panel supporting one or more fiber optic adapters;
at least one optical fiber optically connecting the one or more fiber optic adapters to the opto-electronic device; and
at least one cable manager supported on the housing base, the at least one cable manger comprising:
a base;
a plurality of cable routing channels disposed in the base; and
at least one cable accumulation trough disposed along at least one of the plurality of cable routing channels, wherein the at least one cable accumulation trough is configured to limit bending of the at least one optical fiber to greater than a predetermined bend radius.

16. The fiber optic assembly of claim 15, wherein the base comprises a removable plate, and wherein the plurality of cable routing channels or the at least one cable accumulation trough is disposed on the removable plate.

17. The fiber optic assembly of claim 15, wherein the at least one cable accumulation trough comprises a plurality of cable accumulation troughs.

18. The fiber optic assembly of claim 17, wherein at least some of the plurality of cable accumulation troughs comprise linear accumulation troughs.

19. The fiber optic cable manager of claim 17, wherein at least some the plurality of cable accumulation troughs comprise radial accumulation troughs.

20. A fiber optic assembly comprising:
a housing base configured to support one or more fiber optic communication connections;
a front wall extending from the base and including an adapter panel supporting one or more fiber optic adapters;
lateral housing sidewalls extending from the housing base and disposed at either side of the adapter panel;
an opto-electrical device supported by the housing base;
at least one optical fiber optically connecting the one or more fiber optic adapters to the opto-electronic device; and
at least one cable manager supported on the housing base, the at least one cable manger comprising:
a base;
a plurality of cable routing channels disposed in the base; and
at least one cable accumulation trough disposed along at least one of the plurality of cable routing channels, wherein the at least one cable accumulation trough is configured to limit bending of the at least one optical to greater than a predetermined bend radius.
